(19) United States
(12) Patent Application Publication
(10) Pub. No.: US 2006/0073980 A1
(43) Pub. Date: Apr. 6, 2006

(54) Well treating composition containing relatively lightweight proppant and acid

(75) Inventors: Harold Dean Brannon, Magnolia, TX (US); Joel Lynn Boles, Spring, TX (US); Allan Ray Rickards, Tomball, TX (US); William Dale Wood, Spring, TX (US)

Correspondence Address: JONES & SMITH, LLP, THE RIVIANA BUILDING, 2777 ALLEN PARKWAY, SUITE 800, HOUSTON, TX, 77019-2141, US

(73) Assignee: BJ Services Company, Houston, TX (US)

(21) Appl. No.: 10/954,801

(22) Filed: Sep. 30, 2004

(51) Int. Cl. C09K 8/02; C09K 8/68; E21B 43/00

(52) U.S. Cl. 507/103; 507/203; 507/933

(57) ABSTRACT

A well treating composition contains an aqueous acid and at least one relatively lightweight proppant, preferably having an apparent specific gravity (ASG) less than or equal to 2.45. The acid fracturing composition may used to acid fracture a hydrocarbon reservoir within a subterranean formation of an oil or gas well. The composition may further be used to stimulate the production of hydrocarbons. The proportion of relatively lightweight proppant to acid in the composition is such that the dimensional fracture conductivity (C_{fD}) is in excess of 1.0. The aqueous acid typically has an ASG substantially equal to the ASG of the relatively lightweight particulate. As such, the relatively lightweight particulate is suspended in the aqueous acid.

### FIELD OF THE INVENTION

The present invention relates to novel well treating compositions containing an acid and a relatively lightweight proppant and methods of enhancing the production of hydrocarbons using such compositions.

### BACKGROUND OF THE INVENTION

Acid fracturing is a well known technique which may be employed as an alternative to conventional hydraulic fracturing for stimulation of acid soluble formations, such as dolomites and limestones. It has been used extensively in subterranean sandstone or siliceous formations in oil and gas wells to increase permeability of the formations, thus enhancing the flow of hydrocarbons to the wellbore. The major difference between acid fracturing and hydraulic fracturing is that conductivity in acid fracturing is obtained by etching of the fracture faces with an etching acid instead of by using proppants to prevent the fracture from closing.

The most common method of acid fracturing consists of introducing into the wellbore corrosive, very low pH acids and allowing the acid to react with the surrounding formation. Acids such as hydrochloric acid, formic acid, and acetic acid are characterized by a pH of less than zero and are employed to stimulate calcareous formations. Mixtures of hydrofluoric acid and hydrochloric acid or organic acid, generally referred to as mud acids and primarily used in matrix acidizing, have been used in acid fracturing though their use is limited in light of CaF₂ precipitation upon contact with calcareous materials.

Unfortunately, wells which have been acid fractured frequently suffer rapid production declines due to loss of fracture conductivity as reservoir stresses act to close the etched channels. This phenomena often leads to such formations requiring repeated treatments to maintain the desired well productivity.

Sand has been used in acid treating fluids to prolong acid fracture conductivity by propping the fracture. However, such conventional proppants are of much higher density than the acid in the treating fluids. Thus, sand tends to settle at even very high pumping rates, resulting in little, if any, sand remaining within the productive zone when pumping ceases and the fracture closes. The typical gelling agents used to build sufficient viscosity to carry such proppants is subject to attack by the acid fluids causing the treating fluid to rapidly lose its viscosity, thereby making it very difficult to transport the typical fracturing proppants.

A need exists therefore for an acidizing system which is capable of exhibiting the requisite proppant transport and which provides high fracture conductivity by propping the fracture without settling. The system should further be stable at high temperature while the acid is being spent.

### SUMMARY OF THE INVENTION

The present invention is directed to a well treating composition containing an acid and at least one relatively lightweight proppant. In a preferred embodiment, the relatively lightweight proppant is an ultra light (ULW) proppant having an apparent specific gravity (ASG) less than or equal to 2.45, preferably less than about 1.5, most preferably less than or equal of 1.25. The relatively lightweight proppant has an ASG sufficiently close to the ASG of the aqueous acid and thus are substantially neutrally buoyant in the aqueous acid of the composition. This allows for pumping and satisfactory placement of the proppant in the formation.

The method of the invention is useful in the production of hydrocarbons which have been stimulated by injection of the composition into the formation. The aqueous acid fluid is injected into the formation at high pressure to form fractures within the formation.

When employed in acid fracturing, the aqueous composition of the invention acts as a reactive fluid wherein the acid differentially etches the rock while the relatively lightweight proppant props the fracture, thereby resulting in solubilization of the rock in the acid while the rock is etched around the proppant particulates.

The well treating composition has particular applicability when used to enhance the productivity of hydrocarbons from both hydrocarbon bearing calcareous formations and hydrocarbon bearing siliceous formations

The proportion of relatively lightweight proppant to acid in the composition is such that the created dimensionless fracture conductivity (C_{fD}) is in excess of 1.0, preferably in excess of 10.0.

### BRIEF DESCRIPTION OF THE DRAWINGS

In order to more fully understand the drawings referred to in the detailed description of the present invention, a brief description of each drawing is presented, in which:

FIG. 1 compares the conductivity and stress of an acid soaked proppant versus a proppant not soaked with acid.

FIGS. 2 and 3 are photomicrographs demonstrating acid etching around ultra lightweight proppant particles.

FIG. 4 shows the scale used in the photomicrographs.

### DETAILED DESCRIPTION OF THE PREFERRED EMBODIMENTS

The well treating composition of the invention contains at least one relatively lightweight proppant and an acid.

The acid may be any of those commonly used in acid fracturing. Such acids include inorganic as well as organic acids. Preferred inorganic acids are hydrochloric acid, hydrofluoric acid, and phosphoric acid. Preferred organic acids are formic acid or acetic acid. In addition, the organic acid may be a chelating agent including aminopolycarboxylic acids and sodium, potassium and ammonium salts thereof. N-hydroxyethyl-N, N′, N′-ethylenediaminetriacetic acid (HEDTA) and HEIDA (hydroxyethyliminodiacetic acid) are useful in the present process as free acids and their Na, K, NH₄⁺ salts (and Ca salts). Other aminopolycarboxylic acid members, including EDTA, NTA (nitrilotriacetic acid), DTPA (diethylenetriaminepentaacetic acid), and CDTA (cyclohexylenediaminetetraacetic acid). Mixtures of such acids may further be employed.

The composition of the invention (excluding the proppant and other agents and additives) typically contains between from about 3 to about 28 weight percent of total acid. (When a chelating agent is used, the total amount of acid may be between from about 1 to about 30 weight percent.) The aqueous acid fracturing fluid may contain less than about 3 weight percent, even as low as 0.5 weight percent, acid, though the total minimal acid should be at least about 3 weight percent. For instance, the aqueous acid fracturing fluid may contain between from about 0.5 to about 15 weight percent of a single acid. Most preferably, between from about 5 to about 28 weight percent acid is used when the acid is hydrochloric acid or phosphoric acid. When hydrofluoric acid is used alone, the aqueous fluid contains less than 15 weight percent acid. When formic acid is used, the aqueous fluid generally may contain less than about 10 weight percent formic acid. When acetic acid is used, the aqueous fluid generally may contain less than about 15 weight percent of acetic acid.

Friction reduction and/or viscosifying agents such as synthetic polymers, natural polymers, biopolymers, or viscoelastic surfactants, may be advantageously employed in the acid fluids while pumping. Suitable friction reducing agents include guar, hydroxypropyl guar, acrylamides including acrylamide copolymers, aliphatic alcohols, aliphatic acids, aliphatic amines, aliphatic amides, and alkoxylated alkanolamides. The viscosifying agents provide viscosification of the acid for diversion and/or retardation. Other additives may be employed to assist retardation.

Optionally, weighting agents, such as inorganic salts, may be employed to increase the acid fluid density such that a near neutrally buoyant condition exists with the relatively lightweight proppant. Suitable weighting agents include alkali metal salts, like NaBr and NaCl, CaCl₂, CaBr₂, barite and ZnBr₂.

Typically, the proportion of the at least one relatively lightweight proppant to acid in the composition is such that the created dimensionless fracture conductivity (C_{fD}) is in excess of 1.0. Preferably the proportion of the at least one relatively lightweight proppant to acid is such that the C_{fD} is in excess of 10.0. C_{fD}, a measure of the relative ease with which reservoir fluids are delivered from the reservoir to the wellbore, is defined as:
C_{fD}=k_{f}w/kx_{f}
wherein k_{f} is the fracture permeability, k is reservoir permeability, w is the fracture width and x_{f} is fracture half length. See further Economides, M. J., et al., Reservoir Stimulation in Petroleum Production, pp. 1-1-1-30.

By “relatively lightweight,” it is meant that the proppant has an apparent specific gravity (ASG) (API RP60) that is substantially less than that of a conventional proppant particulate material employed in hydraulic fracturing operations, e.g., sand or having an ASG similar to these materials. In particular, the ASG of the relatively lightweight proppant is less than or equal to 3.25. The relatively lightweight proppant further preferably exhibits crush resistance under conditions as high as 10,000 psi closure stress, API RP 56 or API RP 60, generally between from about 250 to about 8,000 psi closure stress. Relatively lightweight proppants may be chipped, ground, crushed, or otherwise processed to produce particulate material having any particle size or particle shape. Typically, the particle size of the proppants employed in the invention may range from about 4 mesh to about 100 mesh.

Relatively lightweight proppants may be optionally strengthened or hardened with a protective coating or modifying agent which increases the ability of the material to resist deformation by strengthening or hardening the material (e.g., by increasing the elastic modulus of the naturally occurring material). The resulting proppant has increased resistance (e.g., partial or complete resistance) to deformation under in situ formation or downhole conditions as compared to the same type of particles of materials that have not been so modified.

Examples of suitable modifying agents include, but are not limited to, any compound or other material effective for modifying (e.g., crosslinking, coupling or otherwise reacting with) one or more components present in the particulate without degrading or otherwise damaging strength or hardness of the material, and/or without producing damaging by-products during modification that act to degrade or otherwise damage strength or hardness of the material (e.g., without liberating acids such as hydrochloric acid, organic acids, etc.).

Examples of suitable types of modifying agents include, but are not limited to, compounds containing silicon-oxygen linkages, compounds containing cyanate groups, epoxy groups, etc. Specific examples of suitable modifying agents include, but are not limited to, polyisocyanate-based compounds, silane-based compounds, siloxane-based compounds, epoxy-based combinations thereof, etc.

Protective coatings for coating at least a portion of individual particles of the relatively lightweight proppants include, but are not limited to, at least one of phenol formaldehyde resin, melamine formaldehyde resin, urethane resin, or a mixture thereof. Other optional coating compositions known in the art to be useful as hardeners for such materials (e.g., coating materials that function or serve to increase the elastic modulus of the material) may be also employed in conjunction or as an alternative to protective coatings, and may be placed underneath or on top of one or more protective coatings. Such protective and/or hardening coatings may be used in any combination suitable for imparting desired characteristics to a relatively lightweight proppant, including in two or more multiple layers. In this regard successive layers of protective coatings, successive layers of hardening coatings, alternating layers of hardening and protective coatings, etc. are possible. Mixtures of protective and hardening coating materials may also be possible. Protective coatings typically are present in an amount of from about 1% to about 20%, alternatively from about 10% to about 20% by weight of total weight of individual particles.

Preferred relatively lightweight particulates include ceramics, resin coated ceramics, glass microspheres, aluminum pellets or needles, or synthetic organic particulates such as nylon pellets or ceramics.

In a preferred mode, the relatively lightweight proppant is an ultra lightweight (ULW) proppant having an ASG less than or equal to 2.45. Even more preferred are those ULW proppants having an ASG less than or equal to 2.25, preferably less than or equal to 2.0, more preferably less than or equal to 1.75, even more preferably less than or equal to 1.5, most preferably less than or equal to 1.25.

The ULW proppant is preferably selected from a particulate resistant to deformation, including naturally occurring materials, a porous particulate treated with a non-porous penetrating coating and/or glazing material or a well treating aggregate of an organic lightweight material and a weight modifying agent. Mixtures of such proppants may further be used.

Particular examples of naturally occurring materials include, but are not limited to, any naturally occurring material that contains naturally occurring and crosslinkable molecules or compounds (e.g., mixtures of naturally occurring resins, lignins and/or polymers that may be crosslinked), such as those having available hydroxyl groups suitable for crosslinking with one or more crosslinking agent/s. Specific examples of such materials include polysaccharides found in plants that serve to enhance strength of plant materials such as beta (1-4) linked sugars. Examples include, but are not limited to, cellulose and mannans. Other examples of suitable molecules or components include, but are not limited to, natural resins and ligands, specific substances such as polyphenolic esters of glucosides found in tannin from walnut hulls, etc.

Further examples of naturally occurring proppants include ground or crushed shells of nuts such as walnut, coconut, pecan, almond, ivory nut, brazil nut, etc.; ground or crushed seed shells (including fruit pits) of seeds of fruits such as plum, olive, peach, cherry, apricot, etc.; ground or crushed seed shells of other plants such as maize (e.g., corn cobs or corn kernels), etc.; processed wood materials such as those derived from woods such as oak, hickory, walnut, poplar, mahogany, etc., including such woods that have been processed by grinding, chipping, or other form of particalization, processing, etc.

Such materials are disclosed in U.S. Pat. Nos. 6,364,018, 6,330,916 and 6,059,034, all of which are herein incorporated by reference.

In another preferred embodiment, the ULW proppant is a selectively configured porous particulate or non-selectively configured porous particulate, as set forth, illustrated, and defined in U.S. Patent Publication No. 20040040708 A1, published on Mar. 4, 2004, herein incorporated by reference, wherein “porous particulate” is defined as a porous ceramic or porous organic polymeric material including particulates having a porous matrix.

As used herein, the term “selectively configured porous particulate material” refers to any porous particulate, natural or non-natural, which has been chemically treated, such as treatment with a coating material; treatment with a penetrating material; or modified by glazing. The term shall include, but not be limited to, those porous particulate materials which have been altered to achieve desired physical properties, such as particle characteristics, desired strength and/or ASG. The term “non-selectively configured porous particulate material” refers to any porous natural particulate material, including porous natural ceramic materials such as lightweight volcanic rocks, like pumice, as well as perlite and other porous “lavas” like porous (vesicular) Hawaiian Basalt, porous Virginia Diabase, and Utah Rhyolite. In addition, the term refers to a synthetic porous particulate material which has not been chemically treated and which imparts desired physical properties, such as particle characteristics, desired strength and/or ASG.

Preferred porous particulates include those naturally occurring or manufactured or engineered porous ceramic particulates that have an inherent and/or induced porosity. Such particulates also have an inherent or induced permeability, i.e., individual pore spaces within the particle are interconnected so that fluids are capable of at least partially moving through the porous matrix, such as penetrating the porous matrix of the particle, or have inherent or induced non-permeability, individual pore spaces within the particle are disconnected so that fluids are substantially not capable of moving through the porous matrix, such as not being capable of penetrating the porous matrix of the particle. The degree of desired porosity interconnection may be selected and engineered into the non-selectively configured porous particulate material. Furthermore such porous particles may be selected to have a size and shape in accordance with typical fracturing proppant particle specifications (i.e., having a uniform shape and size distribution), although such uniformity of shape and size is not necessary.

In a selectively configured porous particulate material, the porous particulate material is chemically treated in order to impart desired physical properties, such as porosity, permeability, ASG, or combinations thereof to the particulate materials. As such, the inherent and/or induced porosity of a porous material particle may be selected so as to help provide the desired balance between ASG and strength. Such desired physical properties are distinct from the physical properties of the porous particulate materials prior to treatment.

In a preferred embodiment, the porous particulate material is a selectively configured porous particulate material wherein (a) the ASG of the selectively configured porous particulate material is less than the ASG of the porous particulate material; (b) the permeability of the selectively configured porous particulate material is less than the permeability of the porous particulate material; or (c) the porosity of the selectively configured porous particulate material is less than the porosity of the porous particulate material. The strength of the selectively configured porous particulate material is typically greater than the strength of the porous particulate material per se.

The selectively configured porous particulate material may consist of a multitude of coated particulates bonded together. In such manner, the porous material is a cluster of particulates coated with a coating or penetrating layer or glazing layer.

A glazing, penetrating and/or coating material may be chosen to control penetration, such as enhancing or impairing penetration. For instance, glaze-forming, coating and/or penetrating materials may be selectively employed to modify or customize the ASG of a selected porous particulate material. Alternatively, a material may be selected so that it helps structurally support the matrix of the porous particulate material (i.e., increases the strength of the porous matrix) and increases the ability of the particulate to withstand the closure stresses of a hydraulic fractured formation, or other downhole stresses. The coating or penetrating material is typically non-porous.

The coating layer or penetrating material is generally present in the selectively configured porous particulate material in an amount of from about 0.5% to about 10% by weight of total weight. The thickness of the coating layer of the selectively configured porous particulate material is generally between from about 1 to about 5 microns. The extent of penetration of the penetrating material of the selectively configured porous particulate material is from less than about 1% penetration by volume to less than about 25% penetration by volume.

The coating or penetrating fluid or glazing material is typically selected to have an ASG less than the ASG of the porous particulate material so that once penetrated at least partially into the pores of the matrix it results in a particle having a ASG less than that of the porous particulate material prior to coating or penetration, i.e., filling the pore spaces of a porous particulate material results in a solid or substantially solid particle having a much reduced ASG. The penetrating material and/or coating layer and/or glazing layer of the selectively configured porous particulate material may be capable of trapping or encapsulating a fluid having an ASG less than the ASG of the acid fluid.

The desired physical properties may be imparted to a portion or portions of the porous particulate of the selectively configured porous particulate material as well as non-selectively configured porous particulate material, such as on the particle surface of the material particulate, at or in the particle surface of the particulate material, in an area near the particle surface of a particulate material, in the interior particle matrix of a particulate material or a portion thereof, combinations thereof, etc.

Examples of penetrating materials that may be selected for use include, but are not limited to, liquid resins, plastics, cements, sealants, binders or any other material suitable for at least partially penetrating the porous matrix of the selected particle to provide desired characteristics of strength/crush resistance, ASG, etc. It will be understood that selected combinations of any two or more such penetrating materials may also be employed, either in mixture or in sequential penetrating applications.

Examples of resins that may be employed as penetrating and/or coating materials include, but are not limited to, resins and/or plastics or any other suitable cement, sealant or binder that once placed at least partially within a selected particle may be crosslinked and/or cured to form a rigid or substantially rigid material within the porous structure of the particle. Suitable coating layers or penetrating materials include liquid and/or curable resins, plastics, cements, sealants, or binders such as a phenol, phenol formaldehyde, melamine formaldehyde, urethane, epoxy resin, nylon, polyethylene, polystyrene or a combination thereof. In a preferred mode, the coating layer or penetrating material is an ethyl carbamate-based resin.

Further, the porous particulate material may be at least partially selectively configured by glazing, such as, for example, surface glazing with one or more selected non-porous glaze materials. In such a case, the glaze, like the coating or penetrating material, may extend or penetrate at least partially into the porous matrix of the porous particulate material, depending on the glazing method employed and/or the permeability (i.e., connectivity of internal porosity) characteristics of the selected porous particulate material, such as non-connected porosity allowing substantially no penetration to occur. For example, a selected porous particulate material may be selectively configured, such as glazed and/or coated with a non-porous material, in a manner so that the porous matrix of the resulting particle is at least partially or completely filled with air or some other gas, i.e., the interior of the resulting particle includes only air/gas and the structural material forming and surrounding the pores. The inherent and/or induced porosity of a porous material particle may be selected so as to help provide the desired balance between apparent density and strength, and glazing and/or coating with no penetration (or extension of configured area into the particle matrix) may be selected to result in a particle having all or substantially all porosity of the particle being unpenetrated and encapsulated to trap air or other relatively lightweight fluid so as to achieve minimum ASG.

Examples of such glaze-forming materials include, but are not limited to, materials such as magnesium oxide-based material, boric acid/boric oxide-based material, etc.

The desired physical properties of porosity, permeability, ASG, particle size, and chemical resistance may further be present in non-selectively configured porous particulates. Non-selectively configured porous particulates include naturally occurring porous ceramic materials as well as non-natural (synthetic) materials manufactured in a manner that renders the desired characteristics.

Further, the relatively lightweight proppant may be a well treating aggregate composed of an organic lightweight material and a weight modifying agent. The ASG of the organic lightweight material is either greater than or less than the ASG of the well treating aggregate depending on if the weight modifying agent is a weighting agent or weight reducing agent, respectively.

Where the weight modifying agent is a weighting agent, the ASG of the well treating aggregate is at least one and a half times the ASG of the organic lightweight material, the ASG of the well treating aggregate preferably being at least about 1.0, preferably at least about 1.25. In a preferred embodiment, the ASG of the organic lightweight material in such systems is approximately 0.7 and the ASG of the well treating aggregate is between from about 1.05 to about 1.20.

Where the weight modifying agent is a weight reducing agent, the ASG of the weight reducing agent is less than 1.0 and the ASG of the organic lightweight material is less than or equal to 1.1.

The weight modifying agent may be a weighting agent having a higher ASG than the organic lightweight material. The presence of the weighting agent renders a well treating aggregate having a ASG greater than the ASG of the organic lightweight material. Alternatively, the weight modifying agent may be a weight reducing agent having a lower ASG than the organic lightweight material. The presence of the weight reducing agent renders a well treating aggregate having a ASG less than the ASG of the organic lightweight material.

The aggregates are comprised of a continuous (external) phase composed of the organic lightweight material and a discontinuous (internal) phase composed of a weight modifying material. The volume ratio of resin (continuous phase) to weight modifying agent (discontinuous phase) is approximately 75:25. The aggregate particle diameter is approximately 850 microns. The average diameter of the weight modifying agent particulates is approximately 50 microns.

The compressive strength of the aggregate is greater than the compressive strength of the organic lightweight material. When hardened, the aggregate exhibits a strength or hardness to prevent deformation at temperatures and/or formation closure stresses where substantially deformable materials generally become plastic and soften. The weight modifying material may be selected so that the aggregate has the structural support and strength to withstand the closure stresses of a hydraulic fractured formation, or other downhole stresses.

The amount of weight modifying agent in the well treating aggregate is such as to impart to the well treating aggregate the desired ASG. Typically, the amount of weight modifying agent in the well treating aggregate is between from about 15 to about 85 percent by volume of the well treating aggregate, most preferably approximately about 52 percent by volume.

The particle sizes of the weight modifying agent are preferably between from about 10 to about 200 microns.

The organic lightweight material is preferably a polymeric material, such as a thermosetting resin, including polystyrene, a styrene-divinylbenzene copolymer, a polyacrylate, a polyalkylacrylate, a polyacrylate ester, a polyalkyl acrylate ester, a modified starch, a polyepoxide, a polyurethane, a polyisocyanate, a phenol formaldehyde resin, a furan resin, or a melamine formaldehyde resin. The ASG of the organic lightweight material generally less than or equal to 1.1. In a preferred embodiment, the ASG of the material is between about 0.7 to about 0.8.

The amount of organic lightweight material in the aggregate is generally between from about 10 to about 90 percent by volume. The volume ratio of organic lightweight material:weight modifying agent in the aggregate is generally between from about 20:80 to about 85:15, most preferably about 25:75. As an example, using an organic lightweight material having an ASG of 0.7 and a weight modifying agent, such as silica, having an ASG of 2.7, a 20:80 volume ratio would render an aggregate ASG of 2.20 and a 85:15 volume ratio would render an ASG of 1.0; a 75:25 volume ratio would render an ASG of 1.20.

In a preferred mode, the ASG of the well treating aggregate is at least about 0.35. In a most preferred mode, the ASG of the well treating aggregate is at least about 0.70, more preferably 1.0, but not greater than about 2.0.

The weight modifying agent may be sand, glass, hematite, silica, sand, fly ash, aluminosilicate, and an alkali metal salt or trimanganese tetraoxide. In a preferred embodiment, the weight modifying agent is selected from finely ground sand, glass powder, glass spheres, glass beads, glass bubbles, ground glass, borosilicate glass or fiberglass. Further, the weight modifying agent may be a cation selected from alkali metal, alkaline earth metal, ammonium, manganese, and zinc and an anion selected from a halide, oxide, a carbonate, nitrate, sulfate, acetate and formate. For instance, the weight modifying agent may include calcium carbonate, potassium chloride, sodium chloride, sodium bromide, calcium chloride, barium sulfate, calcium bromide, zinc bromide, zinc formate, zinc oxide or a mixture thereof.

Glass bubbles and fly ash are the preferred components for the weight reducing agent.

The aggregates are generally prepared by blending the organic lightweight material with weight modifying agent for a sufficient time in order to form a slurry or a mud which is then formed into sized particles. Such particles are then hardened by curing at temperatures ranging from about room temperature to about 200° C., preferably from about 50 to about 150° C. until the weight modifying agent hardens around the organic lightweight material.

In a preferred mode, the organic lightweight material forms a continuous phase; the weight modifying forming a discontinuous phase.

The ASG of the well treating aggregate is generally less than or equal to 2.0, preferably less than or equal to 1.5, to meet the pumping and/or downhole formation conditions of a particular application, such as hydraulic fracturing treatment, sand control treatment.

Further, the aggregates exhibit a Young's modulus of between about 500 psi and about 2,000,000 psi at formation conditions, more typically between about 5,000 psi and about 500,000 psi, more typically between about 5,000 psi and 200,000 psi at formation conditions, and most typically between about 7,000 and 150,000 psi at formation conditions. The Young's modulus of the aggregate is substantially higher than the Young's modulus of the organic lightweight material or the weighting agent.

The relatively lightweight proppant is preferably substantially neutrally buoyant in the aqueous acid. The term “substantially neutrally” refers to the condition wherein the relatively lightweight particulate has an ASG sufficiently close to the ASG of the aqueous acid solution which allows pumping and satisfactory placement of the proppant into the formation.

The relatively lightweight proppants used in the invention may be prepared such that its ASG is close to the ASG of the aqueous acid. For example, the organic lightweight material may be treated with a weight modifying agent in such a way that the resulting well treating aggregate has a ASG close to the ASG of the aqueous acid so that it is neutrally buoyant or semi-buoyant in a fracturing fluid or sand control fluid. Similarly, the selected porous particulate material may be treated with a selected penetrating material in such a way that the resultant selectively configured porous particulate material has a much reduced ASG such that the selectively configured porous particulate is neutrally buoyant or semi-buoyant in the fracturing fluid.

In light of the small density differential between the acid and the relatively lightweight proppant, the proppant does not tend to settle from the acid. Thus, the well treating composition of the invention allows the introduction of relatively lightweight particulates as neutrally buoyant particles in the aqueous acid, eliminating the need for damaging polymer or fluid loss material. Further, viscosification of the composition further enhances the transport capabilities and proppant placement downhole.

In a most preferred embodiment, the ASG of the relatively lightweight particulate is preferably the same as, but no greater than 0.25 higher than, the ASG of the aqueous acid, preferably the ASG of the relatively lightweight particulate is no greater than 0.20 higher than the ASG of the aqueous acid.

Since the well treating composition of the invention contains substantially buoyant relatively lightweight proppant in the aqueous acid, little, if any, viscosity is required to place the proppant during acid fracturing. Therefore, gelling agents may be used in the acid composition to carry the proppant even if the aqueous acid severely reduces the viscosity of the system. Such gelling agents may therefore further increase the efficiency of the fluid's fracturing capabilities (leak-off control, etc.) and inhibit or retard the reaction of the acid with the formation. This may be beneficial in those instances where the acid reacts too quickly, depleting the acid with very little penetration of the formation.

Any conventional gelling agent typically used in the art for acid fracturing may be used. These include the alkylated trialkyl quaternary aromatic salt such as salicylate or phthalate set forth in U.S. Patent Publication No. 2004/0138071 A1, published on Jul. 15, 2004 Further acceptable gelling agents include crosslinked synthetic polymer gels, non-limiting examples of which are polyvinyl alcohol, poly 2-amino-2-methyl propane sulfonic acid, polyacrylamide, partially hydrolyzed polyacrylamide and copolymers containing acrylamide, terpolymers containing acrylamide, an acrylate, and a third species. Inorganic crosslinking agents are often used with these gels including zirconium oxychloride, zirconium acetate, zirconium lactate, zirconium malate, zirconium citrate, titanium lactate, titanium malate, titanium citrate and the like.

The composition may further contain a gel breaker such as fluoride, phosphate or sulfate anions, to break the linkages of the crosslinked polymer fluid, thus reducing the viscosity of the gel.

Elimination of the need to formulate a complex suspension gel may mean a reduction in tubing friction pressures, particularly in coiled tubing and in the amount of on-location mixing equipment and/or mixing time requirements, as well as reduced costs. Furthermore, the composition of the invention may be employed to simplify hydraulic fracturing treatments or sand control treatments performed through coil tubing, by greatly reducing fluid suspension property requirements. Downhole, a much reduced propensity to settle (as compared to conventional proppant or sand control particulates) may be achieved, particularly in highly deviated or horizontal wellbore sections. In this regard, the disclosed neutral buoyant acid composition may be advantageously employed in any deviated well having an angle of deviation of between about 0° and about 90° with respect to the vertical.

The well treating composition of the invention may further contain a suspending or thixotropic agent, such as those known in the art, including welan gum, xanthan gum, cellulose and cellulosic derivatives such as hydroxyethyl cellulose (HEC), carboxymethyl-hydroxyethyl-cellulose, guar and its derivatives, starch and polysaccharides, succinoglycan, polyalkylene oxides such as polyethylene oxide, bentonite, attapulgite, mixed metal hydroxides, clays such as bentonite and attapulgite, mixed metal hydroxides, oil in water emulsions created with paraffin oil and stabilized with ethoxylated surfactants, poly (methyl vinyl ether/maleic anhydride) decadiene copolymer, carrageenan or scleroglucan.

The well treating composition may further contain conventional additives used in the treatment of subterranean formation to enhance the productivity of the formation or the wellbore, including, but not limited to, corrosion inhibitors, emulsifiers, surfactants, reducing agents (such as stannous chloride), biocides, surface tension reducing agents, friction reducers, scale inhibitors, clay stabilizers, iron control agents, and/or flowback additives may further be used. Such additives, when employed, are typically at lower concentrations conventionally used in the art.

The well treating composition is prepared by mixing the acid solution and (b) homogeneously dispersing in the relatively lightweight proppant.

When employed in well treatments, the composition may be introduced into the wellbore at any concentration deemed suitable or effective for the downhole conditions to be encountered. In a preferred embodiment, the well treating composition containing the substantially neutrally buoyant relatively lightweight proppant is introduced into the subterranean formation at a pressure above a fracturing pressure of the subterranean formation.

The well treating composition of the invention has particular applicability in acid fracturing a subterranean formation, including those formations surrounding oil or gas wells, wherein the fracture face is etched with the acid such that flow channels remain in the formation after the formation is returned to production through which the fluids contained in the formation flow to the wellbore. The composition is reactive in that it reacts with materials within the formation wherein the aqueous acid carries the proppant and the acid etches the rock.

In this embodiment, the composition may be injected into the formation in conjunction at pressures sufficiently high enough to cause the formation or enlargement of fractures, or to otherwise expose the particles to formation closure stress. If desired, the pumping may be minimized or terminated and the pressure lowered on the formation as the composition flows through the formation. The pressure may then be increased.

A subterranean formation of an oil or gas well may be used to enhance the productivity of the formation by stimulating the production of hydrocarbons by injecting at high pressure into the formation the novel fluid. The fluid of the invention has particular applicability in carbonate reservoirs such as limestone or dolomite. Thus, the process of the invention may be applied to a subterranean formation after the completion of acid fracturing to re-stimulate production.

Other treatments may be near wellbore in nature (affecting near wellbore regions) and may be directed toward improving wellbore productivity and/or controlling the production of fracture proppant.

The composition may further be employed as a proppant/sand control medium at temperatures up to about 750° F., and closure stresses up to about 8000 psi. However, these ranges of temperature and closure stress are exemplary only, it being understood that the disclosed materials may be employed as proppant/sand control materials at temperatures greater than about 250° F. and/or at closure stresses greater than about 8000 psi.

The well treating compositions of the invention further has particular applicability in the enhancement of productivity of hydrocarbons from hydrocarbon bearing sandstone or siliceous formations by contacting the formation with a treatment solution containing the aqueous acid fluid containing the relatively lightweight proppant. (As used herein the term “siliceous” refers to the characteristic of having silica and/or silicate. Most sandstone formations are composed of over 50-70% sand quartz particles, i.e. silica (SiO₂) bonded together by various amounts of cementing material including carbonate (calcite or CaCO₃) and silicates.) Since the relatively lightweight proppants are not composed of SiO₂, they are not, unlike conventional sand proppants, in that they are not subject to reaction with mud acids like HF.

Particle size of the disclosed particulate materials may be selected based on factors such as anticipated downhole conditions and/or on relative strength or hardness of the particulate material/s selected for use in a given application. In this regard, larger particle sizes may be more desirable in situations where a relatively lower strength particulate material is employed.

The following examples will illustrate the practice of the present invention in a preferred embodiment. Other embodiments within the scope of the claims herein will be apparent to one skilled in the art from consideration of the specification and practice of the invention as disclosed herein. It is intended that the specification, together with the example, be considered exemplary only, with the scope and spirit of the invention being indicated by the claims which follow. All parts are given in terms of weight units except as may otherwise be indicated.

### EXAMPLES

### Example 1

Approximately 300 grams of LiteProp™ 125 proppant having a size of about 14/30 mesh and a product of BJ Services Company, were placed into a 1000-ml container and sufficient 10% HCl was added to cover the proppant. The container was then placed into a defined area with a temperature of approximately 90° F. After 24 hours, the excess acid was removed and the acid-soaked proppant was effectively washed with deionized water. The washed samples were then allowed to dry at 120-140° F. Each sample was visually examined.

The acid-soaked proppant appeared to have changed in color from brown to reddish brown to red. No other effect on the proppant was visually determined.

Conductivity tests were then performed according to API RP 61 (1^{st} Revision, Oct. 1, 1989) using an API conductivity cell with Ohio sandstone wafer side inserts to simulate the producing formation. The test proppant was placed between the sealed sandstone wafers. The conductivity cell was then placed on a press while stress was applied at 100 psi/minute until the target temperature was reached. Fluid was then allowed to flow through the test pack maintaining Darcy flow. The differential pressure was measured across 5 inches of the pack using a “ROSEMOUNT” differential pressure transducer (#3051C). Flow was measured using Micromotion mass flow meters and data points were recorded every 2 minutes for 50 hours. An Isco 260D programmable pump applied and maintained effective closure pressure.

Experimental parameters for the conductivity evaluation are shown in Tables I-III below.

TABLE I

| Fluid | Deionized Water |
|---|---|
| Particulate (grams) | 31.5 |
| Top Core Width (mm) | 10.970 |
| Bot Core (mm) | 9.680 |
| Width Pack, initial (cm) | 0.220 |

TABLE II

| | | | |
|---|---|---|---|
| Closure Pressure (psi) | 1000-4000 | Concentration | 1 lbs/ft2 |
| Fluid Pressure (psi) | 500 | | |

TABLE III

| Test Data | Temp | Water Rate | Viscosity | DP | Width | Conductivity | Permeability | Closure |
|---|---|---|---|---|---|---|---|---|
| * Time (Hours) | ° C. | mls/min | cp | psi | Inches | md-ft | Darcies | Stress psi |
| 0 | 56.24 | 4.90 | 0.49 | 0.0092 | 0.20 | 7,078 | 436 | 1,184 |
| 10 | 52.93 | 4.90 | 0.52 | 0.0106 | 0.19 | 6,458 | 402 | 1,079 |
| 20 | 52.92 | 5.10 | 0.52 | 0.0109 | 0.19 | 6,530 | 406 | 1,143 |
| 30 | 52.56 | 4.85 | 0.52 | 0.0108 | 0.19 | 6,312 | 399 | 2,012 |
| 40 | 52.71 | 4.80 | 0.52 | 0.0110 | 0.19 | 6,106 | 396 | 2,004 |
| 50 | 67.40 | 4.90 | 0.42 | 0.0107 | 0.16 | 5,159 | 394 | 2,023 |
| 0 | 64.26 | 4.85 | 0.44 | 0.0112 | 0.16 | 5,081 | 388 | 3,975 |
| 0 | 93.21 | 4.90 | 0.30 | 0.0782 | 0.16 | 509 | 39 | 4,083 |
| 10 | 93.20 | 4.90 | 0.30 | 0.0839 | 0.15 | 475 | 38 | 3,830 |
| 20 | 93.20 | 4.90 | 0.30 | 0.0875 | 0.15 | 455 | 36 | 3,764 |
| 30 | 93.21 | 4.90 | 0.30 | 0.0871 | 0.15 | 457 | 37 | 3,869 |
| 40 | 93.19 | 4.90 | 0.30 | 0.0866 | 0.15 | 460 | 37 | 3,682 |
| 50 | 93.20 | 4.90 | 0.30 | 0.0942 | 0.15 | 423 | 34 | 3,953 |

* -- Values given represent an average of an hour's data at each given point.

As may be seen from the results of this example, a relatively lightweight particulate that is substantially neutrally buoyant in a 10% HCl aqueous solution, may advantageously be employed to yield a proppant pack having relatively good conductivity. Strength of the acid-soaked proppant was improved compared to the non-acid-soaked proppant.

Closure stress testing was further performed at closure stresses ranging from 1000 psi to 6000 psi on the proppant without acid soaking and the acid soaked proppant. The proppant in each instance was LiteProp™ of 14/20 mesh. Results of this testing is given in Table IV below:

TABLE IV

Permeability, Darcies

| | | Acid Soaked |
|---|---|---|
| Closure | LiteProp ™ 14/30 | LiteProp ™ 14/30 |
| Stress, psi | @ 1 lb/ft² | @1 lb/ft² |
| 1000 | 3222 | 6530 |
| 2000 | 1011 | 6106 |
| 4000 | 583 | 2780 |
| 6000 | 200 | 500 |

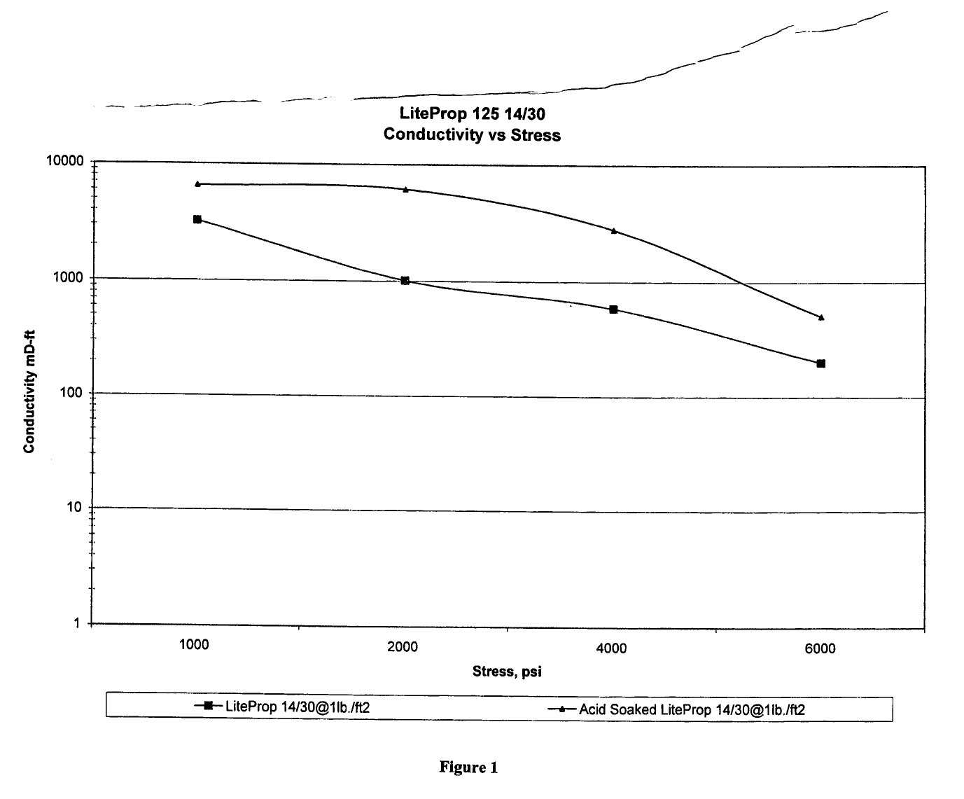

The Examples illustrate the improvements obtained using acid soaked proppant at increasing closure stresses. FIG. 1 compares the effect on conductivity and stress for the acid soaked proppant versus the proppant not treated with an acid. In addition to near-term well productivity improved, the results indicate that use of the acid-soaked proppant is less likely to result in fracture closure/etching channel collapse, common in wells which are acid fracture stimulated, than the non-acid soaked proppant.

### Example 2

Conductivity tests were conducted, as set forth in Example 1, using LiteProp™ 125 of 14/30 mesh wherein the pack was loaded at 0.06 lb/ft². Sta-Live acid, a delayed acid product of BJ Services Company, was pumped through the pack at 20 mls/min.

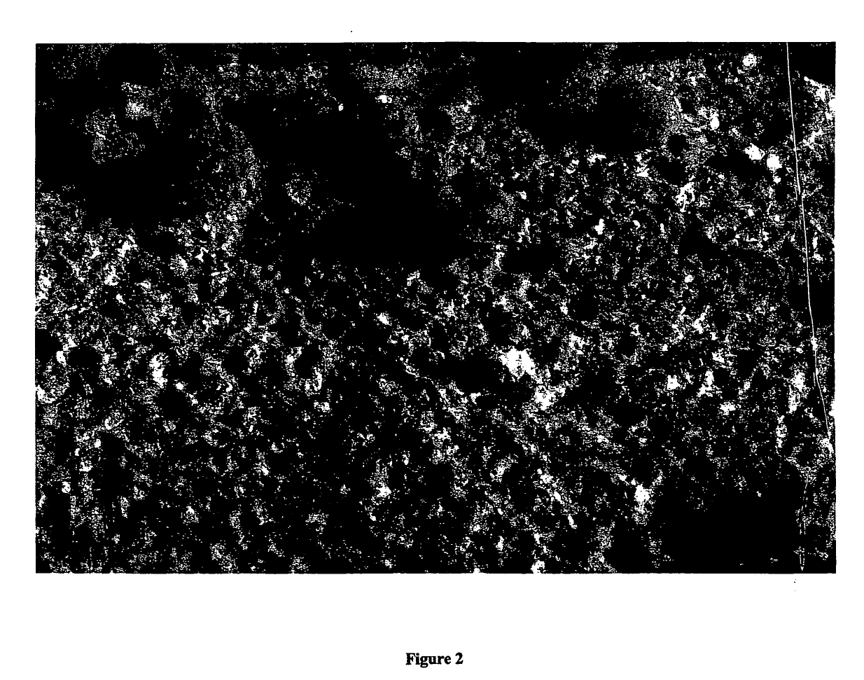

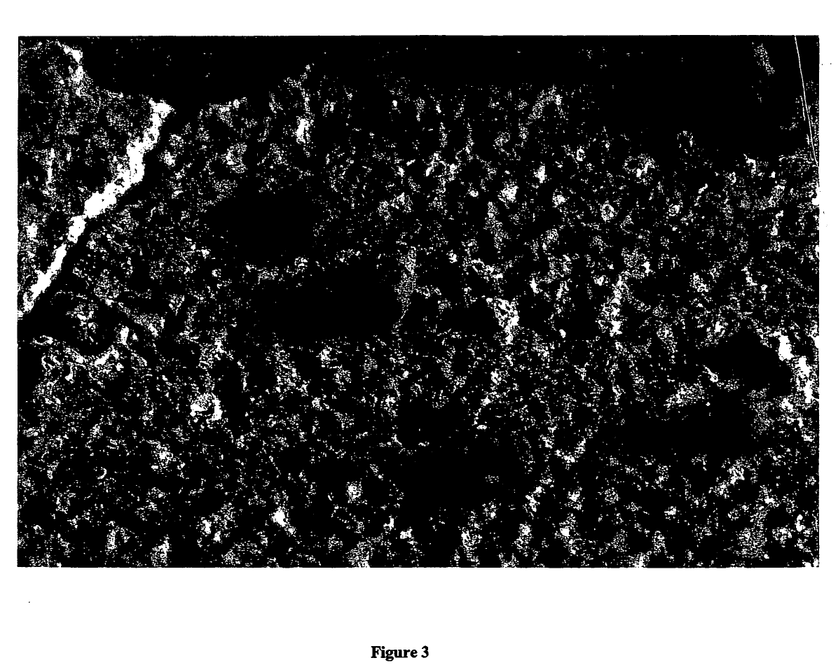

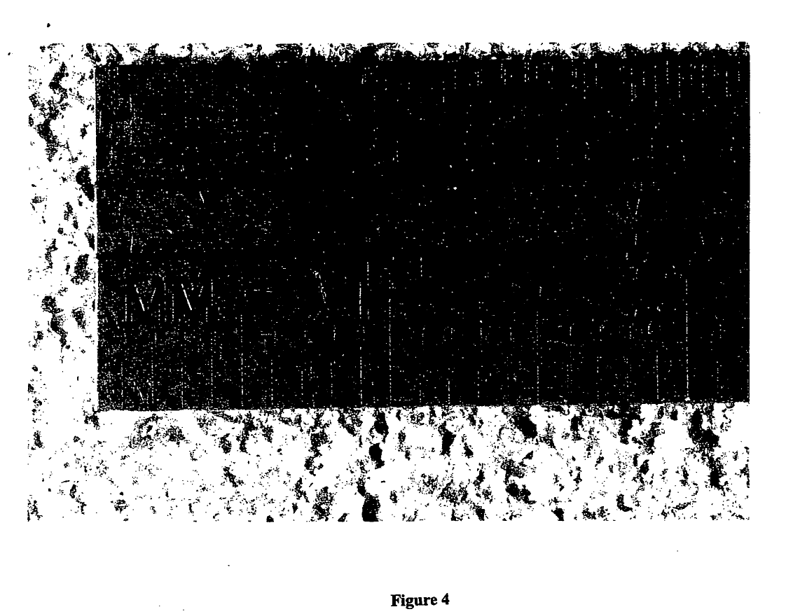

As set forth in FIGS. 2 and 3, the relatively lightweight proppant as illustrated by the resin of the resin-coated proppant, is not damaged by the high strength of the acid during acid fracturing. This is further demonstrated by the etching of the acid with solubilized rock around the proppant particulates, which is indicative of greater open areas for fluid flow and thus higher conductivity. Without soaking the proppant in acid, the rock etches evenly.

From the foregoing, it will be observed that numerous variations and modifications may be effected without departing from the true spirit and scope of the novel concepts of the invention.

What is claimed is:

1. A method of acid fracturing a subterranean formation of an oil or gas well to stimulate production of hydrocarbons, the method comprising the steps of:
providing an aqueous acid fracturing fluid which comprises at least one relatively lightweight proppant; and
injecting the aqueous acid fracturing fluid into the formation at high pressure to form fractures within the formation.

2. The method of claim 1, wherein the at least one relatively lightweight proppant is an ultra lightweight (ULW) proppant having an apparent specific gravity less than or equal to 2.45.

3. The method of claim 2, wherein the amount of acid in the aqueous acid fracturing fluid is between from about 3 to about 28 weight percent.

4. The method of claim 3, wherein the aqueous acid fracturing fluid contain an acid selected from hydrofluoric acid, hydrochloric acid, phosphoric acid, formic acid or acetic acid or mixtures thereof.

5. The method of claim 2, wherein the aqueous acid fracturing fluid contains less than 3 weight percent of hydrofluoric acid, hydrochloric acid, phosphoric acid, formic acid or acetic acid or mixtures thereof, the total amount of acid in the aqueous acid fracturing fluid being between from about 3 to about 28 weight percent.

6. The method of claim 4, wherein the aqueous acid fracturing fluid contains less than about 10 weight percent of formic acid.

7. The method of claim 4, wherein the aqueous acid fracturing fluid contains less than about 15 weight percent of acetic acid.

8. The method of claim 1, wherein the aqueous acid fracturing fluid further comprises a gelling agent.

9. The method of claim 2, wherein the apparent specific gravity of the at least one ULW proppant is less than or equal to 1.5.

10. The method of claim 9, wherein the apparent specific gravity of the at least one ULW proppant is less than or equal to 1.25.

11. The method of claim 1, wherein the proportion of the at least one relatively lightweight proppant to acid is such that the dimensional fracture conductivity (C_{fD}) is in excess of 1.0.

12. The method of claim 11, wherein the proportion of the at least one relatively lightweight proppant to acid is such C_{fD} is in excess of 10.0.

13. The method of claim 1, wherein the at least one relatively lightweight proppant is substantially neutrally buoyant.

14. The method of claim 1, wherein the at least one relatively lightweight proppant contains a protective or hardened coating.

15. The method of claim 1, wherein the aqueous acid fracturing fluid further contains a friction reduction or viscosification agent selected from synthetic polymers, natural polymers, biopolymers, and viscoelastic surfactants or mixtures thereof.

16. The method of claim 13, wherein the aqueous acid fracturing fluid further contains a weighting agent.

17. A method of stimulating production of hydrocarbons in an oil or gas well comprising injecting into a subterranean formation an aqueous reactive proppant fluid, the fluid comprising an acid and at least one relatively lightweight proppant, wherein the aqueous reactive proppant fluid is injected into the formation at a pressure sufficient to form fractures within the formation.

18. The method of claim 17, wherein the at least one relatively lightweight proppant is an ultra lightweight (ULW) proppant having an apparent specific gravity less than or equal to 2.45.

19. The method of claim 18, wherein the apparent specific gravity of the at least one ULW proppant is less than or equal to 1.5.

20. The method of claim 19, wherein the apparent specific gravity of the at least one ULW proppant is less than or equal to 1.25.

21. The method of claim 17, wherein the proportion of the at least one relatively lightweight proppant to acid is such that the dimensional fracture conductivity (C_{fD}) is in excess of 1.0.

22. The method of claim 21, wherein the proportion of the at least one relatively lightweight proppant to acid is such that C_{fD} is in excess of 10.0.

23. The method of claim 17, wherein the at least one relatively lightweight proppant is substantially neutrally buoyant.

24. The method of claim 17, wherein the at least one relatively lightweight proppant contains a protective or hardened coating.

25. A method of enhancing the productivity of hydrocarbons from a hydrocarbon bearing siliceous formation, the method comprising contacting the formation with an aqueous treatment solution comprising an acid and at least one relatively lightweight proppant.

26. The method of claim 25, wherein the at least one relatively lightweight proppant is an ultra lightweight (ULW) proppant having an apparent specific gravity less than or equal to 2.45.

27. The method of claim 26, wherein the apparent specific gravity of the at least one ULW proppant is less than or equal to 1.5.

28. The method of claim 25, wherein the proportion of the at least one relatively lightweight proppant to acid is such that the dimensional fracture conductivity (C_{fD}) is in excess of 1.0.

29. The method of claim 28, wherein the proportion of relatively lightweight proppant to acid is such that C_{fD} is in excess of 10.0.

30. The method of claim 25, wherein the at least one relatively lightweight proppant is substantially neutrally buoyant.

31. The method of claim 25, wherein the aqueous treatment solution further contains a friction reduction or viscosification agent.

32. The method of claim 25, wherein the aqueous treatment solution further contains a weighting agent.

33. A well treating composition comprising an acid and at least one relatively lightweight proppant.

34. The well treating composition of claim 33, wherein the composition is an acid fracturing composition, the acid being an etching acid.

35. The well treating composition of claim 34, wherein the composition contains between about 3 to 28% by weight of acid.

36. The well treating composition of claim 33, wherein the composition further comprises a gelling agent.

37. The well treating composition of claim 33, wherein the relatively lightweight proppant is an ultra lightweight (ULW) proppant having apparent specific gravity less than or equal to 2.45.

38. The well treating composition of claim 37, wherein the apparent specific gravity of the at least one ULW proppant is less than or equal to 1.5.

39. The well treating composition of claim 38, wherein the apparent specific gravity of the at least one ULW proppant is less than or equal to 1.25.

40. The well treating composition of claim 33, wherein the at least one relatively lightweight proppant is substantially neutrally buoyant.

41. The well treating composition of claim 33, wherein the at least one relatively lightweight proppant contains a protective or hardened coating.
